(19) United States
(12) Patent Application Publication
(10) Pub. No.: US 2021/0112637 A1
(43) Pub. Date: Apr. 15, 2021

(54) HOB APPARATUS

(71) Applicant: BSH Hausgeräte GmbH, Munich (DE)

(72) Inventor: Christoph Becke, Grosskarolinenfeld (DE)

(21) Appl. No.: 16/629,575

(22) PCT Filed: Jun. 15, 2018
(86) PCT No.: PCT/EP2018/065992

§ 371 Date: Jan. 9, 2020

(30) Foreign Application Priority Data
Jul. 11, 2017 (DE) 10 2017 211 798.2

(51) Int. Cl. H05B 6/12; F21V 8/00

(52) U.S. Cl. CPC H05B 6/1218; G02B 6/0008; G02B 6/0006

(57) ABSTRACT

A hob apparatus, in particular an induction hob apparatus includes a hob panel, a heating element, a light supply unit arranged at least in part on a side of the heating element remote from the hob panel and supplying light in at least one operating condition, and a waveguide unit transporting in the operating condition light from the light supply unit to a side of the heating element facing the hob panel.

The invention relates to a hob apparatus as claimed in claim 1, and to a method for operating a hob apparatus as claimed in claim 13.

International patent application WO 2016/185301 A1 has already disclosed a hob apparatus having a hob panel and heating elements that, in an installed position, are arranged below the hob panel. In an installed position, the heating elements are arranged above a space dividing element that takes the form of a shielding element. In an installed position, a light supply unit is arranged on a side of the space dividing element remote from the heating element, and illuminates a part of the hob panel through a cutout in the space dividing element. The possibility of arranging the light supply unit in a region above the space dividing element is prevented by the high temperatures, which makes targeted illumination difficult to achieve.

It is the object of the invention in particular to specify a generic apparatus that has improved properties as regards illumination. According to the invention, the object is achieved by the features of claims 1 and 13, while advantageous embodiments and developments of the invention can be found in the subclaims.

The invention relates to a hob apparatus, in particular an induction hob apparatus, having at least one hob panel, at least one heating element, at least one light supply unit that is arranged at least in part and in particular entirely on a side of the heating element remote from the hob panel and that supplies light in at least one operating condition, and at least one waveguide unit that, in the operating condition, transports light from the light supply unit to a side of the heating element facing the hob panel.

Advantageous illumination may in particular be achieved with a construction of this kind. In particular, it is possible to illuminate selected locations in a targeted manner, as a result of which for example light-supported user guidance becomes possible, in which at least one item of information can be conveyed to a user in particular by an illumination. As a result, it is possible in particular to achieve optimized and/or intuitive interaction for the user by means of a hob having the hob apparatus, since in particular it is possible to avoid transferring to a hob top information conveyed via a display. In particular, information can be presented at the location at which a procedure takes place. Thanks to the waveguide unit, the light supply unit can be arranged in particular in a region that is not temperature-critical, and which is located in particular on a side of the hob panel remote from the heating element, as a result of which in particular it is possible to achieve a long-lasting construction and/or low costs, as a result of less expensive light sources of the light supply unit.

The term “hob apparatus”, in particular an “induction hob apparatus”, should in particular be understood to mean at least a part, and in particular a subassembly, of a hob, in particular an induction hob. The term “hob panel” should in particular be understood to mean a unit that is provided for cooking vessels to be placed on in at least one operating condition, and that is provided in particular for the purpose of forming part of a hob external casing, in particular of the hob apparatus and/or a hob having the hob apparatus. In particular, in an installed position the hob panel forms a part of the hob external casing that faces a user. In particular, at least the majority of the hob panel is made of glass and/or glass ceramic. The term “at least the majority” should in particular be understood to mean a proportion, in particular a mass and/or volumetric proportion, of at least 70%, in particular at least 80%, advantageously at least 90% and preferably at least 95%.

The term “heating element” should be understood in this context in particular to mean an element that is provided for the purpose of converting energy, preferably electrical energy, into heat and in particular supplying it to at least one cooking vessel. Advantageously, the heating element in particular takes the form of an induction heating element. In particular, the heating element taking the form of an induction heating element is provided for the purpose of generating an electromagnetic alternating current field in particular of a frequency between 20 kHz and 100 kHz, which is provided in particular for the purpose of being converted into heat in a cooking vessel bottom that is placed on, in particular a metal, preferably ferromagnetic, cooking vessel bottom, by inducing eddy currents and/or by the effects of an alternating magnetic field.

The term “light supply unit” should in particular be understood to mean a unit that has at least one light source and that supplies light, in particular visible light, in particular by means of the light source, in at least one operating condition. In particular, the light supply unit has at least two, in particular at least four, advantageously at least eight, particularly advantageously at least twelve and preferably a multiplicity of light sources. At least one light source of the light supply unit could be for example a display unit, preferably a backlit display unit, in particular a matrix display unit, preferably an LCD display, an OLED display and/or electronic paper. In particular, at least one light source of the light supply unit and advantageously at least the majority of the light sources of the light supply unit is/are an LED. The term “visible light” should in particular be understood to mean electromagnetic radiation in a wavelength range of 380 nm to 780 nm.

The expression that the light supply unit is arranged “at least in part” on a side of the heating element remote from the hob panel should in particular be understood to mean that at least one light source of the light supply unit is arranged on a side of the heating element remote from the hob panel, wherein in particular at least one further light source of the light supply unit could be arranged on a side of the heating element facing the hob panel.

The term “operating condition” should in particular be understood to mean a condition in which a main plane of extent of the hob panel is oriented at least substantially parallel to a siting surface and in particular a hob having the hob apparatus is located in an installed position, and in which in particular the heating element supplies energy, in particular electromagnetic energy, to a cooking vessel located in particular above the heating element, and heats the cooking vessel in particular by means of the energy. The term “main plane of extent” of an object should in particular be understood to mean a plane parallel to the largest side face of the smallest notional geometric cube that is large enough to envelop the object, in particular running through the center point of the cube. The term “substantially parallel” should in particular be understood here to mean an orientation of a direction in relation to a reference direction, in particular in a plane, wherein the direction deviates from the reference direction in particular by less than 8°, advantageously by less than 5° and particularly advantageously by less than 2°.

In at least one mounted condition, the light supply unit could be arranged in particular on a carrier unit other than a hob electronics unit. In particular, the light supply unit is arranged in at least one mounted condition on a hob electronics unit, in particular a printed circuit board of the hob electronics unit. The hob apparatus has in particular at least one hob electronics unit, which has in particular at least one control unit and, in particular in at least one operating condition, controls, by open and/or closed loop control, at least the heating element and/or at least one supply unit that supplies the heating element in particular with energy.

The term “waveguide unit” should in particular be understood to mean a unit that has at least one waveguide and in particular, in at least one operating condition, transports in particular visible light, in particular in targeted and/or directional manner, from a first region to at least one second region that is different from and/or spaced from the first. The term “waveguide” should in particular be understood to mean an element that, in at last one operating condition, transmits, in particular transports, electromagnetic radiation, in particular visible light and/or infrared radiation, advantageously both visible light and infrared radiation, in the direction of longitudinal extent of the waveguide, in particular by way of total internal reflection within the waveguide. In particular, in at least one operating condition, the waveguide prevents at least electromagnetic radiation from entering and/or exiting in directions that are oriented at least substantially perpendicular to the direction of longitudinal extent of the waveguide, at least to a substantial extent. In particular, the waveguide unit has at least two, in particular at least four, advantageously at least eight, particularly advantageously at least twelve and preferably a multiplicity of waveguides. The term “direction of longitudinal extent” of an object should in particular be understood to mean a direction that is oriented parallel to the longest side of the smallest notional geometric cube that is large enough to envelop the object. The term “substantially perpendicular” should in particular here define an orientation of a direction in relation to a reference direction, wherein the direction and the reference direction form an angle of 90°, in particular as seen in a plane, and the angle has a maximum deviation of in particular less than 8°, advantageously less than 5° and particularly advantageously less than 2°.

At least the majority of the waveguide could for example be made of glass fiber and/or silicone. In particular, at least the majority of the waveguide could be made of at least one heat-resistant material and be functional and/or undamaged and/or unimpaired in particular at temperatures of at least 230° C. and advantageously at least 250° C. In particular, at least the majority of the waveguide could take a flexible form and/or be made of at least one flexible material, as a result of which in particular complex shapes and/or types and/or structures of waveguides can be made.

The hob apparatus has in particular at least one holding unit, which, in an installed position, in particular determines and/or defines a position of the waveguide unit in relation to the light supply unit. In particular, in at least one mounted condition, the holding unit fixes at least one waveguide of the waveguide unit in relation to at least one light source of the light supply unit.

In particular, as viewed perpendicular to a main plane of extent of the hob panel, at least the majority of the light supply unit and/or the waveguide unit extend over the entire surface of the hob panel. As a result, in particular a presentation extending over a large surface is made possible, in particular outside of a display, as a result of which in particular presented information can also be supplied such that it is readily visible and/or identifiable by a user at a distance.

For example, the hob panel could have at least one coating that could, in particular in regions provided with an illumination, take an at least substantially and in particular completely transparent form. In particular, by means of a structure and/or form of the coating, a structure and/or form of an illumination could be defined and/or determined. As a result, in particular waveguides could be arranged at a relatively great distance from the hob panel. In particular, the size of a light-emitting surface of the waveguide could be selected such that a mounting below the hob panel could be at least substantially insensitive to tolerances.

The term “provided” should in particular be understood to mean specially programmed, formed and/or equipped. The fact that an object is provided for a particular function should in particular be understood to mean that the object fulfills and/or performs this particular function in at least one condition of use and/or operating condition.

The light supply unit could for example have precisely one light source. The waveguide unit could in particular have at least two waveguides that could in particular both be associated with the light source of the light supply unit. Preferably, the light supply unit has at least two light sources, with each of which at least one waveguide of the waveguide unit is associated. The expression that a waveguide is “associated” with a light source should in particular be understood to mean that, in at least one operating condition, the waveguide transports the light from the light source and, in at least one operating condition, in particular at least one end of the waveguide is arranged in the vicinity of the light source. This can in particular create a great variety of possible structures, since in particular each light source can be used individually by the waveguide associated therewith for illumination purposes and hence in particular a multiplicity of illumination patterns and/or ways of illuminating can be created.

In particular, at least two waveguides of the waveguide unit could be associated with each light source of the light supply unit. A number of light sources of the light supply unit could in particular be smaller than a number of waveguides of the waveguide unit. Preferably, the light supply unit has a number of light sources that corresponds to a number of waveguides of the waveguide unit. In particular, the number of light sources of the light supply unit is equal to and/or identical to a number of waveguides of the waveguide unit. This enables in particular targeted and/or individually single illumination.

It is moreover proposed that the waveguide unit should have at least one waveguide of which at least the majority, as viewed perpendicular to a main plane of extent of the hob panel, is arranged in particular laterally next to the heating element. In particular, at least the majority of at least one waveguide of the waveguide unit, as viewed perpendicular to a main plane of extent of the hob panel, is arranged in the vicinity of the heating element, in particular laterally next to the heating element, and in particular has a maximum spacing, in the main plane of extent, of at most 50%, in particular at most 25%, advantageously at most 15% and preferably at most 10% of a maximum extent of the heating element in the main plane of extent. The term “extent” of an object should in particular be understood to mean a maximum spacing between two points of a perpendicular projection of the object onto a plane. In particular, the holding unit has at least one holding element that defines a position of the waveguide, of which at least the majority is arranged next to the heating element as viewed perpendicular to a main plane of extent of the hob panel, relative to at least one light source of the light supply unit, and at least the majority of the at least one holding element is arranged, in particular in an installed position, below the heating element. As a result, particularly simple mounting of the waveguide can in particular be achieved, as a result of which in particular low costs for mounting can be made possible. In particular, a targeted illumination of a delimitation of the heating element can be made possible, as a result of which a position of the heating element and thus in particular at least one possible position for placing on, can be presented to a user in a simple manner.

It is furthermore proposed that the waveguide unit should have at least one waveguide that, as viewed perpendicular to a main plane of extent of the hob panel, is arranged at least in part in a region of the heating element. The expression that a waveguide of the waveguide unit is arranged, as viewed perpendicular to a main plane of extent of the hob panel, “at least in part” in a region of the heating element should in particular be understood to mean that the waveguide has at least one sub-region that, as viewed perpendicular to a main plane of extent of the hob panel, is arranged in a region of the heating element, wherein the waveguide could have at least one further sub-region arranged outside the region of the heating element. In particular, the holding unit has at least one holding element of which, in an installed position, at least the majority is arranged in a plane spanned by the heating element and which, in particular in relation to a center point and/or center of gravity of the holding element, is surrounded by the heating element over an angular range of at least 180°, in particular at least 270°, advantageously at least 300° and preferably at least 330°. As a result, in particular it can even be made possible to supply illumination in a region of the heating element, as a result of which in particular a high level of user convenience and/or a high level of user safety can be achieved.

Moreover, it is proposed that the waveguide unit should have at least one waveguide that, in an installed position, is arranged at least in part above the heating element. The expression that a waveguide of the waveguide unit is arranged, in an installed position, “at least in part” above the heating element should in particular be understood to mean that the waveguide has at least one sub-region that, in an installed position, is arranged above the heating element, wherein the waveguide could have at least one further sub-region that, in the installed position, is arranged below the heating element. In particular, the waveguide has at least one sub-region with a longitudinal extent that, in the installed position, is oriented at least substantially parallel to a main plane of extent of the heating element and, as viewed perpendicular to a main plane of extent of the heating element, is arranged in particular by a proportion of at least 10%, in particular at least 20%, advantageously at least 30% and preferably at least 40%, of a maximum extent of the heating element in the main plane of extent above the heating element. In particular, as viewed perpendicular to a main plane of extent of the heating element, the sub-region of the waveguide is arranged by a proportion of at most 95%, in particular at most 90%, advantageously at most 80% and preferably at most 70% of a maximum extent of the heating element in the main plane of extent above the heating element. The term “longitudinal extent” of an object should in particular be understood to mean an extent of the object along a direction of longitudinal extent of the object. As a result, in particular a high level of flexibility can be achieved, since in particular any desired location on a hob panel can be illuminated in targeted manner.

It is further proposed that the waveguide unit should have at least one waveguide that, in at least one mounted condition, has a minimum spacing measured in particular perpendicular to the hob panel of at most 10 mm, in particular at most 7 mm, advantageously at most 5 mm, particularly advantageously at most 3 mm and preferably at most 2 mm from the hob panel. As a result, in particular an undesired and/or excessive scattering of light transported by the waveguide from its exit from the waveguide until it reaches the hob panel can be avoided, as a result of which in particular an illumination that is optimized and/or of pinpoint accuracy can be made possible.

The light supply unit and the heating element could for example be provided for separate mounting. Preferably, the hob apparatus has at least one structural unit that includes the heating element and the light supply unit. In particular, the light supply unit and the heating element, in particular in the form of the structural unit, are provided for common mounting. The term “structural unit” should in particular be understood to mean a structurally cohesive unit that is provided in particular for common mounting, in particular pre-mounting, and whereof the components are mounted in particular before the structural unit is mounted in a hob external casing. As a result, in particular a rapid and/or simple mounting can be achieved, as a result of which in particular low costs can be achieved.

The structural unit could for example include only the heating element and the light supply unit. Preferably, the structural unit includes in particular, in addition to the heating element and the light supply unit, the waveguide unit. As a result, in particular mounting of the waveguide unit in relation to the light supply unit can be undertaken before mounting in a hob external casing, as a result of which in particular good accessibility can be achieved during mounting of the structural unit and in particular this structural unit can be mounted in the hob external casing in a simple manner, in particular subsequently.

For example, the light supply unit could include only light sources that are each associated with precisely one heating element. Preferably, the hob apparatus has at least one further heating element, wherein the light supply unit has at least one light source that is simultaneously associated with the heating element and the further heating element. The expression that a light source is simultaneously “associated” with the heating element and the further heating element should in particular be understood to mean that, in at least one operating condition, the light source illuminates the heating element and the further heating element and/or that the light source illuminates the heating element in at least one first operating condition and illuminates the further heating element in at least one second operating condition that is different from the first operating condition. In particular, in at least one operating condition the light source indicates a position of the heating element and/or the further heating element to a user by means of the light supplied from the light source. As a result, in particular an inexpensive embodiment and/or a small number of light sources can be made possible.

It is further proposed that the hob apparatus should have at least one control unit that is provided for the purpose of outputting at least one item of information to a user in the operating condition, by means of the light supply unit. In particular, the control unit operates the light supply unit in the operating condition. The term “control unit” should in particular be understood to mean an electronic unit that is preferably at least in part integrated into a closed-loop and/or open-loop control unit of a hob and is preferably provided for the purpose of controlling at least the heating element and/or the light supply unit by closed-loop and/or open-loop control. Preferably, the control unit includes a processor unit and in particular, in addition to the processor unit, a storage unit in which there is stored a closed-loop and/or open-loop control program that is provided for execution by the processor unit. The item of information could for example be an item of information regarding at least a position of the heating element and/or a selection of the heating element and/or at least a heating power and/or at least a heating power history and/or at least a temperature and/or at least a temperature history and/or a cooking status and/or a heating phase and/or a timer and/or a time and/or a residual heat and/or an error message and/or a child lock. In particular, the control unit provides a user with information, in the operating condition, about a device status and/or about at least one operating option and/or about at least one device feature. As a result, in particular a particularly high level of user convenience can be achieved, since a user can be kept informed in particular continuously in an intuitive and/or clearly presented manner.

In particular, user convenience can be optimized by a method for operating a hob apparatus having at least one hob panel and at least one heating element, wherein, in at least one operating condition, light from a side of the heating element remote from the hob panel is transported to a side of the heating element facing the hob panel.

Here, the hob apparatus is not intended to be restricted to the embodiment and use described above. In particular, for the purpose of fulfilling a mode of functioning described herein, the hob apparatus can have a number of individual elements, components and units other than the number mentioned herein.

Further advantages become apparent from the description of the drawing below. The drawing illustrates exemplary embodiments of the invention. The drawing, the description and the claims contain numerous features in combination. The person skilled in the art will also favorably consider the features individually and group them together to form useful further combinations.

In the drawing:

FIG. 1 shows a schematic plan view of a hob with a hob apparatus,

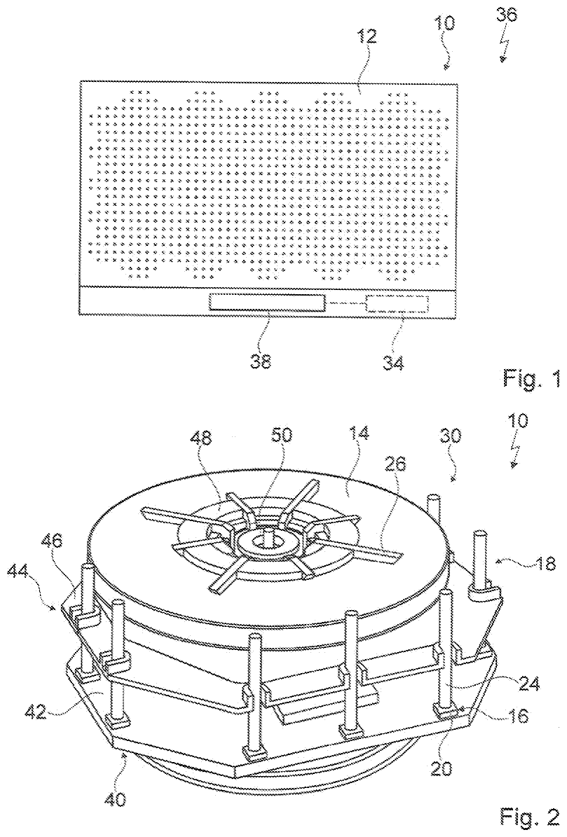

FIG. 2 shows a diagrammatic illustration of a structural unit of the hob apparatus, wherein the structural unit includes a heating element, part of a light supply unit, part of a waveguide unit and part of a holding unit,

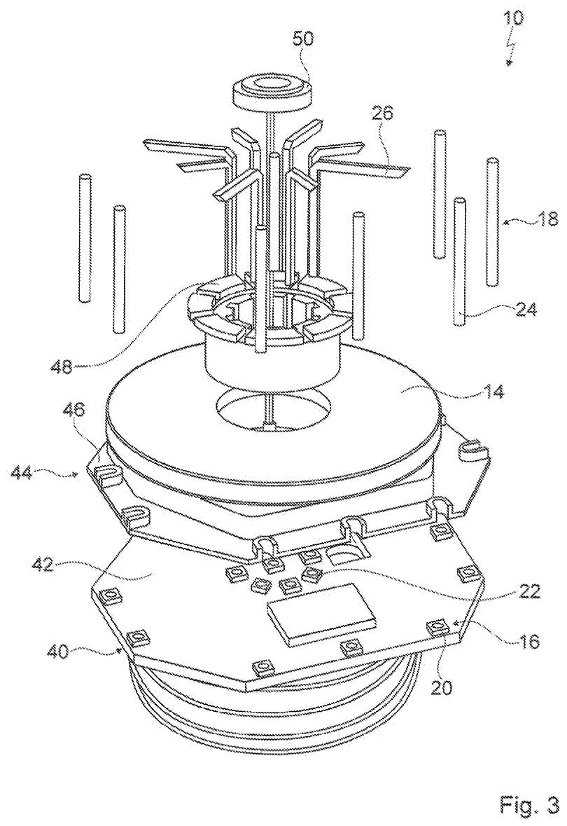

FIG. 3 shows a schematic exploded illustration of the structural unit,

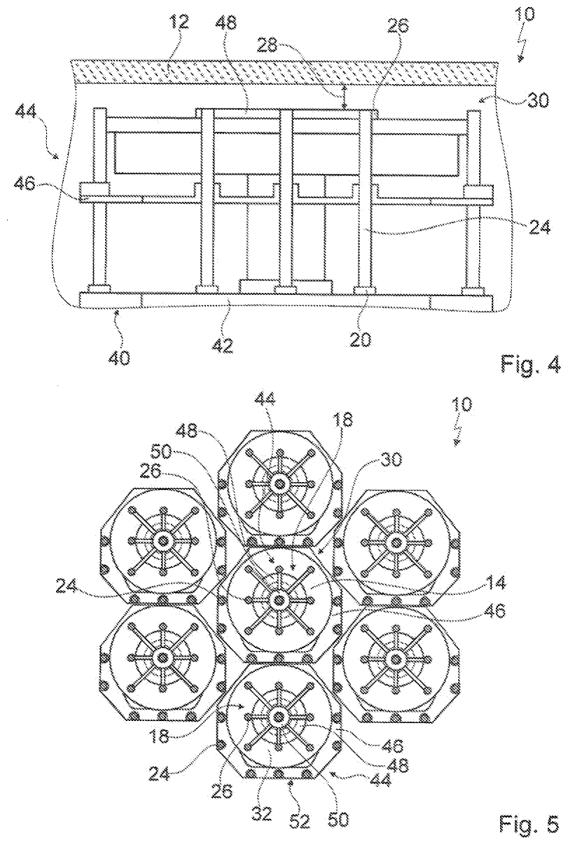

FIG. 4 shows a schematic sectional illustration of a hob panel of the hob apparatus and the structural unit, and

FIG. 5 shows a schematic plan view of the structural unit and a plurality of further structural units of the hob apparatus.

FIG. 1 shows a hob 36 that takes the form of an induction hob, with a hob apparatus 10 that takes the form of an induction hob apparatus.

The hob apparatus 10 has a hob panel 12. In a mounted condition, the hob panel 12 forms part of a hob external casing, in particular a hob external casing in particular of the hob 36. The hob panel 12 is provided for the purpose of having cooking vessels (not illustrated) placed on it.

The hob apparatus 10 has a heating element 14 (cf. FIGS. 2 to 5). In an installed position, the heating element 14 is arranged below the hob panel 12. The heating element 14 is provided for the purpose of heating cooking vessels that are placed on the hob panel 12 above the heating element 14. The heating element 14 takes the form of an induction heating element.

The hob apparatus 10 has a user interface 38 for inputting and/or selecting operating parameters, for example a heating power and/or heating power density and/or a heating zone. The user interface 38 is provided for the purpose of outputting a value of an operating parameter to a user.

The hob apparatus 10 has a control unit 34. The control unit 34 is provided for the purpose of performing actions and/or changing settings, in dependence on operating parameters that are input by way of the user interface 38. In a heating operating condition, the control unit 34 controls a supply of energy to the heating element 14 by closed-loop control.

The hob apparatus 10 has a light supply unit 16. In one operating condition, the light supply unit 16 supplies light, in particular for the purpose of illuminating the hob panel 12. The control unit 34 operates the light supply unit 16 in the operating condition. In an installed position, the light supply unit 16 is arranged on a side of the heating element 14 remote from the hob panel 12 (cf. FIG. 4).

In the present exemplary embodiment, the light supply unit 16 includes a multiplicity of light sources 20, 22. In the figures, in each case only one of a plurality of objects present is provided with a reference numeral. The light supply unit 16 has sixteen light sources 20, 22 per heating element 14.

The hob apparatus 10 has a hob electronics unit 40. In a mounted condition, the light sources 20, 22 of the light supply unit 16 are arranged on the hob electronics unit 40.

The hob electronics unit 40 has a sub-unit 42 for each heating element 14. In the present exemplary embodiment, sixteen light sources 20, 22 of the light supply unit 16 are arranged on the sub-unit 42 of the hob electronics unit 40 per heating element 14. In an installed position, a main plane of extent of the sub-unit 42 of the hob electronics unit 40 is arranged substantially parallel to a main plane of extent of the heating element 14. In an installed position, the majority of the sub-unit 42 of the hob electronics unit 40 is arranged below the heating element 14.

The hob apparatus 10 has a waveguide unit 18. In the operating condition, the waveguide unit 18 transports light from the light supply unit 16 to a side of the heating element 14 facing the hob panel 12. The waveguide unit 18 extends from the side of the heating element 14 remote from the hob panel 12 to the side of the heating element 14 facing the hob panel 12. In the operating condition, the waveguide unit 18 transports light from the light supply unit 16 past the heating element 14 and/or through a region of the heating element 14.

In the present exemplary embodiment, the waveguide unit 18 has a multiplicity of waveguides 24, 26. The waveguide unit 18 has sixteen waveguides 24, 26 per heating element 14. A waveguide 24, 26 of the waveguide unit 18 is associated with each light source 20, 22 of the light supply unit 16. In the present exemplary embodiment, a number of light sources 20, 22 of the light supply unit 16 corresponds to a number of waveguides 24, 26 of the waveguide unit 18.

In the present exemplary embodiment, the waveguide unit 18 has seven waveguides 24, of which the majority, as viewed perpendicular to a main plane of extent of the hob panel 12, are arranged next to the heating element 14. The waveguides 24 of the waveguide unit 18 of which, as viewed perpendicular to a main plane of extent of the hob panel 12, the majority are arranged next to the heating element 14 are arranged, in relation to a center point and/or center of gravity of the heating element 14, over an angular range in the main plane of extent of substantially 180°, in particular regularly and advantageously in the peripheral direction around the heating element 14.

The hob apparatus 10 has a holding unit 44. In a mounted condition, the holding unit 44 defines a position of the waveguides 24, 26 of the waveguide unit 18 in relation to the light sources 20, 22 of the light supply unit 16. The holding unit 44 has a holding element 46 that defines a position of the waveguides 24—of which, as viewed perpendicular to a main plane of extent of the hob panel 12, the majority are arranged next to the heating element 14—relative to the corresponding light sources 20 of the light supply unit 16. In an installed position, the majority of the holding element 46 is arranged below the heating element 14.

In the present exemplary embodiment, the waveguide unit 18 has nine waveguides 26, which, as viewed perpendicular to a main plane of extent of the hob panel 12, are arranged in a region of the heating element 14. A waveguide 26 of the waveguide unit 18 which, as viewed perpendicular to a main plane of extent of the hob panel 12, is arranged in a region of the heating element 14 is arranged substantially at a center point and/or center of gravity of the heating element 14. Eight waveguides 26 of the waveguide unit 18 that are arranged, as viewed perpendicular to a main plane of extent of the hob panel 12, in a region of the heating element 14, are arranged, in relation to a center point and/or center of gravity of the heating element 14 in the main plane of extent, over an angular range of substantially 360°, in particular regularly and advantageously in the peripheral direction around the center point and/or center of gravity of the heating element 14, in the main plane of extent.

The holding unit 44 has a holding element 50 that defines a position of the waveguide 26—which, as viewed perpendicular to a main plane of extent of the hob panel 12, is arranged substantially at a center point and/or center of gravity of the heating element 14 in the main plane of extent—in relation to the corresponding light source 22 of the light supply unit 16. In an installed position, the majority of the holding element 50 is arranged in a main plane of extent spanned by the heating element 14.

The waveguide unit 18 has eight waveguides 26, which in an installed position are arranged in part above the heating element 14. In the present exemplary embodiment, the waveguide unit 18 has four waveguides 26 that, as viewed perpendicular to a main plane of extent of the heating element 14, are arranged over a proportion of substantially 15% of a maximum extent of the heating element 14 in the main plane of extent above the heating element 14. In the present exemplary embodiment, the waveguide unit 18 has four waveguides 26 that, as viewed perpendicular to a main plane of extent of the heating element 14, are arranged over a proportion of substantially 25% of a maximum extent of the heating element 14 in the main plane of extent above the heating element 14.

The waveguides 26 of the waveguide unit 18 that, as viewed perpendicular to a main plane of extent of the heating element 14, are arranged over a proportion of substantially 15% of a maximum extent of the heating element 14 in the main plane of extent above the heating element 14, and the waveguides 26 of the waveguide unit 18 that, as viewed perpendicular to a main plane of extent of the heating element 14, are arranged over a proportion of substantially 25% of a maximum extent of the heating element 14 in the main plane of extent above the heating element 14, are arranged alternately adjacent to one another.

The holding unit 44 has a holding element 48 that defines a position of the waveguides 26—which, in an installed position, are arranged in part above the heating element 14—in relation to the corresponding light sources 22 of the light supply unit 16. In an installed position, the majority of the holding element 48 is arranged in a plane spanned by the heating element 14.

In the present exemplary embodiment, the waveguides 24, 26 of the waveguide unit 18 have a minimum spacing 28 of substantially three mm from the hob panel 12. A region of the waveguides 24, 26 of the waveguide unit 18 that is closest to the hob panel 12 has a minimum spacing 28 of substantially three mm from the hob panel 12.

The hob apparatus 10 has a structural unit 30. The structural unit 30 includes the heating element 14 and part of the light supply unit 16. In the present exemplary embodiment, the structural unit 30 includes the heating element 14 and sixteen light sources 20, 22 of the light supply unit 16.

In addition to the heating element 14 and the part of the light supply unit 16, the structural unit 30 includes part of the waveguide unit 18. In the present exemplary embodiment, the structural unit 30 includes sixteen waveguides 24, 26 of the waveguide unit 18.

In particular in addition to the heating element 14 and the part of the light supply unit 16 and the part of the waveguide unit 18, the structural unit 30 includes part of the holding unit 44. In the present exemplary embodiment, the structural unit 30 includes three holding elements 46, 48, 50 of the holding unit 44.

The hob apparatus 10 includes a multiplicity of further heating elements 32 (cf. FIG. 5). Of the further heating elements 32, only six are illustrated in the figures. Moreover, of the further heating elements 32, only one is described below.

In an installed position, the further heating element 32 is arranged below the hob panel 12. The further heating element 32 is provided for the purpose of heating cooking vessels that are placed on the hob panel 12 above the further heating element 32. The further heating element 32 takes the form of an induction heating element. The further heating element 32 takes a form identical to the heating element 14, so the reader is referred to the description given in respect of the heating element 14 for a description of the further heating element 32.

The hob apparatus 10 has one further structural unit 52 per further heating element 32. The further structural unit 52 is identical to the structural unit 30, so the reader is referred to the description given in respect of the structural unit 30 for a description of the further structural unit 52.

In the present exemplary embodiment, the light supply unit 16 includes three light sources 20, which are associated simultaneously with the heating element 14 and the further heating element 32. Of the light sources 20 that are associated simultaneously with the heating element 14 and the further heating element 32, only one is described below.

As viewed perpendicular to a main plane of extent of the heating element 14, the light source 20 of the light supply unit 16—which is associated simultaneously with the heating element 14 and the further heating element 32—is arranged between the heating element 14 and the further heating element 32.

In one operating condition, the control unit 34 outputs information to a user by way of the light supply unit 16. In one operating condition, the control unit 34 informs a user of a position of a cooking vessel that is placed on, by way of the light supply unit 16. In one operating condition, the control unit 34 informs a user of a heating power supplied to a cooking vessel, by way of the light supply unit 16.

In a method for operating the hob apparatus 10, in one operating condition light is transported from a side of the heating element 14 remote from the hob panel 12 to a side of the heating element 14 facing the hob panel 12.

### REFERENCE NUMERALS

10 Hob apparatus
12 Hob panel
14 Heating element
16 Light supply unit
18 Waveguide unit
20 Light source
22 Light source
24 Waveguide
26 Waveguide
28 Spacing
30 Structural unit
32 Further heating element
34 Control unit
36 Hob
38 User interface
40 Hob electronics unit
42 Sub-unit
44 Holding unit
46 Holding element
48 Holding element
50 Holding element
52 Further structural unit

1-13. (canceled)

14. A hob apparatus, in particular an induction hob apparatus, said hob apparatus comprising:
a hob panel;
a heating element;
a light supply unit arranged at least in part on a side of the heating element remote from the hob panel and supplying light in at least one operating condition; and
a waveguide unit transporting in the operating condition light from the light supply unit to a side of the heating element facing the hob panel.

15. The hob apparatus of claim 14, wherein the light supply unit includes at least two light sources, each of the two light sources being associated to at least one waveguide of the waveguide unit.

16. The hob apparatus of claim 14, wherein the light supply unit includes a number of light sources in correspondence to a number of waveguides of the waveguide unit.

17. The hob apparatus of claim 14, wherein the waveguide unit includes a waveguide which is predominantly arranged next to the heating element, as viewed perpendicular to a main plane of extent of the hob panel.

18. The hob apparatus of claim 14, wherein the waveguide unit includes a waveguide which is arranged at least in part in a region of the heating element, as viewed perpendicular to a main plane of extent of the hob panel.

19. The hob apparatus of claim 14, wherein the waveguide unit includes a waveguide which is arranged at least in part above the heating element in an installed position.

20. The hob apparatus of claim 14, wherein the waveguide unit includes a waveguide having a minimum spacing of at most 10 mm from the hob panel in at least one mounted condition.

21. The hob apparatus of claim 14, further comprising a structural unit configured to include the heating element and the light supply unit.

22. The hob apparatus of claim 21, wherein the structural unit is configured to include the waveguide unit.

23. The hob apparatus of claim 14, further comprising a further heating element, said light supply unit including a light source which is associated to both the heating element and the further heating element.

24. The hob apparatus of claim 14, further comprising a control unit configured to output in the operating condition an item of information to a user via the light supply unit.

25. A hob, in particular an induction hob, comprising a hob apparatus, said hob apparatus comprising a hob panel, a heating element, a light supply unit arranged at least in part on a side of the heating element remote from the hob panel and supplying light in at least one operating condition, and a waveguide unit transporting in the operating condition light from the light supply unit to a side of the heating element facing the hob panel.

26. The hob of claim 25, wherein the light supply unit includes at least two light sources, each of the two light sources being associated to at least one waveguide of the waveguide unit.

27. The hob of claim 25, wherein the light supply unit includes a number of light sources in correspondence to a number of waveguides of the waveguide unit.

28. The hob of claim 25, wherein the waveguide unit includes a waveguide which is predominantly arranged next to the heating element, as viewed perpendicular to a main plane of extent of the hob panel.

29. The hob of claim 25, wherein the waveguide unit includes a waveguide which is arranged at least in part in a region of the heating element, as viewed perpendicular to a main plane of extent of the hob panel.

30. The hob of claim 25, wherein the waveguide unit includes a waveguide which is arranged at least in part above the heating element in an installed position.

31. The hob of claim 25, wherein the waveguide unit includes a waveguide having a minimum spacing of at most 10 mm from the hob panel in at least one mounted condition.

32. The hob of claim 25, wherein the hob apparatus includes a structural unit configured to include the heating element and the light supply unit.

33. The hob of claim 32, wherein the structural unit is configured to include the waveguide unit.

34. The hob of claim 25, wherein the hob apparatus includes a further heating element, said light supply unit including a light source which is associated to both the heating element and the further heating element.

35. The hob of claim 25, wherein the hob apparatus includes a control unit configured to output in the operating condition an item of information to a user via the light supply unit.

36. A method for operating a hob apparatus including a hob panel and a heating element, said method comprising transporting light from a side of the heating element remote from the hob panel to a side of the heating element facing the hob panel.
